(19) United States
(12) Patent Application Publication
(10) Pub. No.: US 2021/0303444 A1
(43) Pub. Date: Sep. 30, 2021

(54) Method, apparatus and computer program and user interface and technique to debug software code

(71) Applicant: Shruthi Raghavan, San Jose, CA (US)

(72) Inventor: Shruthi Raghavan, San Jose, CA (US)

(21) Appl. No.: 16/833,662

(22) Filed: Mar. 29, 2020

(51) Int. Cl. G06F 11/36; G06N 20/00

(52) U.S. Cl. CPC G06F 11/3636; G06F 11/3656; G06F 11/3664; G06N 20/00

(57) ABSTRACT

A method, program and a graphical user interface to navigate through different watch points at which a variable changes its value and look at instantaneous values of all the variables in the same stack at that point of time, while hovering on the code on a graphical integrated development environment. This method may also include a method to determine which data to store based on anomalies on both the data and the times at which this data was written. The anomalies might be calculated using standard anomaly detection techniques and/or machine learning

### CROSS REFERENCE TO RELATED APPLICATION

This application claims the benefit of U.S. Provisional Application No. 62/888,454

### BACKGROUND OF THE INVENTION

A general debugger only goes forward in time, and the user has to know which variables need watchpoints or where the break points need to be placed before hand. This leads to painful iterations and rerunning which makes debugging the most expensive part of a software development. Some debuggers let you go backwards in time, but that too is not good enough. Being able to move anywhere in time requires expensive data storage. Time series db offers fast compressed storage of variables with respect to time, since it only stores time points at which a variable changes its value, while making query fast as well. Also existing tools does not offer incremental mode of recompilation and execution,

### DETAILED DESCRIPTION OF SOME EMBODIMENTS

In one embodiment, the computer program is modified and statements are inserted, where values of variables are written to time series database (db).

The statements above are inserted whenever variables were modified in the program

In another embodiment the time series db could be replaced by any other form of database

In one embodiment there is an graphical user interface that displays the computer code before modification.

In [004], the user interface displays the possible values and timestamps as user hovers a pointer over the program variables, by querying the time series db in [001]

In [005], the user may click one timestamp and that becomes the active time. Now every time user hovers overs a variable, only the values at the instant of active time is shown by querying. the time series database written in [001]

In the same or another embodiment, the user may make changes to the code and incrementally recompile and execute that local code, block or function, thereby rewriting the time series database values

In another embodiment, only values that represent anomalies are written to the database.

In another embodiment the anomalies in [008] may be calculated by a neural network, such as the recurrent neural networks with long short term memory (LSTM) cells.

In the same or another embodiment, the anomalies might be used in the user interface to identify possible values and timestamps which could lead to the discovery of a bug in the computer program

In an embodiment, an incremental interpreter may be used to flag software output which are syntactically incorrect, thereby training the neural network better, during testing, validation and actual use

In another embodiment, the generated intermediate assembly code may be padded with nop(null) statements, so that incremental modification would keep the same memory footprint

As disclosed herein, the deep neural network may include a physical neural network. A physical neural network may be a type of artificial neural network in which

an electrically adjustable resistance material may be used to emulate the function of a
neural synapse. “Physical” neural network may be used to emphasize the reliance on
physical hardware used to emulate neurons as opposed to software-based approaches
which simulate neural networks. More generally the term physical neural network may be
applicable to other artificial neural networks in which a resistor or other electrically
adjustable resistance material is used to emulate a neural synapse.

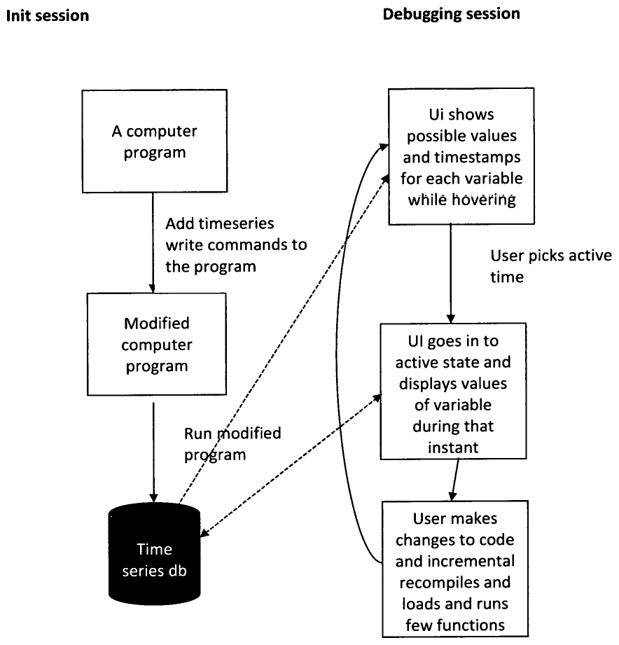

Referring to FIG. 1 is illustrated an exemplary flow of an exemplary system for generation and storage of variable value change events during a program execution. As shown in FIG. 1, in one embodiment, there can be a graphical user interface that queries the database and presents to the user to help her or him during debugging

It may be appreciated by a person with ordinary skill in the art, in light of and in

accordance with the teachings of the present invention any compatible form of Neural
network model may be employed for natural language to software input translation.

It may be appreciated by a person with ordinary skill in the art, in light of and in

accordance with the teachings of the present invention any compatible machine learning
algorithms may be employed, for example, support vector machines and the like.

It may be appreciated by a person with ordinary skill in the art, in light of and in

accordance with the teachings of the present invention any other compatible natural
languages and or other types of software languages

In various embodiments, the system described herein may include a designated

software that may be executed using a local computer, on cloud, and other like systems as
may be appreciated by a person with ordinary skill in the art, in light of and in accordance
with the teachings of the present invention.

Those skilled in the art will readily recognize, in light of and in accordance with

the teachings of the present invention, that any of the foregoing steps and/or system
modules may be suitably replaced, reordered, removed and additional steps and/or system
modules may be inserted depending upon the needs of the particular application, and that
the systems of the foregoing embodiments may be implemented using any of a wide
variety of suitable processes and system modules, and is not limited to any particular
computer hardware, software, middleware, firmware, microcode and the like. For any
method steps described in the present application that can be carried out on a computing
machine, a typical computer system can, when appropriately configured or designed,
serve as a computer system in which those aspects of the invention may be embodied.

The invention has been described above by way of illustration, and the specific

embodiments disclosed are not intended to limit the invention to the particular forms
disclosed.

What is claimed is:

1. A method, program, graphical user interface that stores values of all variables in a software program in a compact time series database to help with navigating through different points of execution in time

2. An incremental mode, that runs only the code in the current scope and neighboring vicinity of modified code, while initializing the values at a given time. In the incremental mode the code is only run for a specified time interval.

3. Depending on prior knowledge of code changes and bug context, or by employing machine learning algorithms certain variables can be sampled at higher or lower granularity

4. A graphical user interface which displays all the possible values in the time interval of interest set by user. The time of interest also depends on the value of interest and vice versa

5. This method may also include a method to determine which data to write to the database based on anomalies on both the data and the times at which this data was written.

6. The anomalies described above, might be calculated using standard anomaly detection techniques and/or machine learning

7. A method to pad assembly code with null operations (nop) so that incremental changes and recompilation of one or few functions would not modify memory references and footprint of other functions

8. Ability to continue execution after incrementally modifying program memory, recompiled by technique mentioned above
